(19) United States
(12) Patent Application Publication
(10) Pub. No.: US 2026/0249874 A1
(43) Pub. Date: Aug. 27, 2026

(54) OCCLUSION MODELING FOR POLICY SIMULATION

(71) Applicant: Torc Robotics, Inc., Blacksburg, AR (US)

(72) Inventors: Marat Kopytjuk, Heilbronn (DE); Margarita Kunjavskaja, Gerlingen (DE); Maximilian Yassine Beyen, Leutenbach (DE); Simon Baeuerle, Kassel (DE); Maximilian Koeper, Ostfildern (DE)

(21) Appl. No.: 19/066,011

(22) Filed: Feb. 27, 2025

(51) Int. Cl. B60W 60/00; G06T 7/50; G06T 15/00; G06V 10/26

(52) U.S. Cl. CPC B60W 60/001; G06T 7/50; G06T 15/00; G06V 10/26

(57) ABSTRACT

A system is configured to: generate a plurality of faces for a surface representing each object of a plurality of objects in a simulated environment from a perspective of an ego vehicle; transform or project each face of the plurality of faces representing each object of the plurality of objects in a pixel space; generate a respective rasterized pixel space based upon the transformed or projected pixel space for each object of the plurality of objects; compute and sort Z-buffer values for each of the respective rasterized pixel space for each object of the plurality of objects to identify a proportion by which an object of the plurality of objects is occluded by another object of the plurality of objects from a perspective of an ego vehicle.

### TECHNICAL FIELD

The field of the disclosure relates generally to policy simulation and, more specifically, occlusion modeling using a computationally efficient occlusion computation method for policy simulation.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes (i.e., a policy) to reach the planned destination for execution by a controller or a control module. Controller technologies use control theory to determine how to translate desired behaviors and trajectories into actions undertaken by the vehicle through its dynamic mechanical components. This includes steering, braking and acceleration.

An ADAS stack is a collection of sensors, software, and firmware that work together to enable autonomous driving. The ADAS stack includes a sensing layer, a software layer, and a network layer. The sensing layer generally captures data corresponding to 360° view of an autonomous vehicle using camera or light detection and ranging (LiDAR) sensors for detecting lane markers, road signs, and other objects including vehicle in the surrounding environment of the autonomous vehicle. The software layer includes autonomous vehicle software algorithms that process data of the camera or LiDAR sensors. The autonomous vehicle software algorithms are trained on large datasets to adapt to different driving scenarios or conditions. The network layer generally enables dedicated short-range communications (DSRC) vehicle-to-everything (V2X) communication. However, one of many challenges for the ADAS stack is to have a dataset that includes many different types of driving scenarios or conditions including occluded objects.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system including at least one memory configured to store machine executable instructions, and at least one processor coupled to the at least one memory is disclosed. The at least one processor is configured to execute the machine executable instructions to (i) generate a plurality of faces for a surface representing each object of a plurality of objects in a simulated environment; (ii) transform or project each face of the plurality of faces representing each object of the plurality of objects in a pixel space from a perspective of an ego vehicle; (iii) generate a respective rasterized pixel space based upon the transformed or projected pixel space for each object of the plurality of objects; (iv) compute depth buffer or Z-buffer values for the respective rasterized pixel space for each object of the plurality of objects; and (v) based upon sorting of the computed depth buffer or Z-buffer values for each pixel coordinate of the pixel of the respective rasterized pixel space, identify a proportion by which an object of the plurality of objects is occluded by another object of the plurality of objects from the perspective of the ego vehicle.

In another aspect, a computer-implemented method is disclosed. The computer-implemented method includes (i) generating a plurality of faces for a surface representing each object of a plurality of objects in a simulated environment; (ii) transforming or projecting each face of the plurality of faces representing each object of the plurality of objects in a pixel space from a perspective of an ego vehicle; (iii) generating a respective rasterized pixel space based upon the transformed or projected pixel space for each object of the plurality of objects; (iv) computing depth buffer or Z-buffer values for the respective rasterized pixel space for each object of the plurality of objects; and (v) based upon sorting of the computed depth buffer or Z-buffer values for each pixel coordinate of the pixel of the respective rasterized pixel space, identifying a proportion by which an object of the plurality of objects is occluded by another object of the plurality of objects from the perspective of the ego vehicle.

In yet another aspect, an application server including at least one memory configured to store machine executable instructions, and at least one processor coupled to the at least one memory is disclosed. The at least one processor is configured to execute the machine executable instructions to (i) generate a plurality of faces for a surface representing each object of a plurality of objects in a simulated environment; (ii) transform or project each face of the plurality of faces representing each object of the plurality of objects in a pixel space from a perspective of an ego vehicle; (iii) generate a respective rasterized pixel space based upon the transformed or projected pixel space for each object of the plurality of objects; (iv) compute depth buffer or Z-buffer values for the respective rasterized pixel space for each object of the plurality of objects; and (v) based upon sorting of the computed depth buffer or Z-buffer values for each pixel coordinate of the pixel of the respective rasterized pixel space, identify a proportion by which an object of the plurality of objects is occluded by another object of the plurality of objects from the perspective of the ego vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an example software stack architecture of an autonomous vehicle;

FIG. 5 is an example illustration of a closed loop simulation using the software stack architecture shown in FIG. 4;

FIG. 6 is an example illustration of a closed loop simulation;

FIG. 7 is an example illustration of policy simulation corresponding to an occlusion scenario;

FIG. 8 is an example of object occlusion computation;

FIG. 9 illustrates an example implementation of object occlusion computation shown in FIG. 8; and

FIG. 10 is a flow-chart of an example method of object occlusion computation.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

Vehicle-to-Vehicle (V2V) communication: V2V communication, as described herein, refers to a technology allowing vehicles to communicate with each other, for example, for sharing information, data, etc., using wireless communication protocols. Wireless communication protocols used for V2V communications may include, for example, short-range radio communication (DSRC). Information or data shared using V2V communication may include, but is not limited only to, a vehicle speed, heading, braking status, etc.

Vehicle-to-everything (V2X) communication: Vehicle-to-everything (V2X) communication, as described herein, refers to a technology allowing vehicles to communicate with other vehicles, infrastructure, other road users, etc., for sharing information, data, etc., using wireless communication protocols. Wireless communication protocols used for V2X communications may include, for example, short-range radio communication (DSRC), Wi-Fi, 4G, 5G, satellite communication network, Bluetooth, cellular technologies according to third generation partnership project (3GPP) standards, etc. Information or data shared using V2X communication may include, but is not limited only to, a vehicle speed, heading, braking status, traffic light status, road sign information, traffic information, etc.

Autonomous vehicle-to-autonomous vehicle (AV2AV) pairing: Autonomous vehicle-to-autonomous vehicle (AV2AV) pairing, as described herein, refers to two autonomous vehicles communicating with each other using V2V communication. Particularly, an autonomous vehicle that has entered into a degraded state (or degraded mode), or that is performing a minimal risk maneuver (MRM), and referenced herein as a degraded autonomous vehicle, is paired with another autonomous vehicle to receive information or data that increases safety of the degraded autonomous vehicle. The information of data shared among the two autonomous vehicles includes, but not limited to, sensor configurations, an autonomous vehicle diagnostic information, a failure state, a geographic location, one or more autonomous vehicle outputs, etc. The AV2AV pairing is implemented in such a way that an external entity cannot breach the AV2AV connection, and misuse of hijack the communication between two paired autonomous vehicles using AV2AV communication technique.

Perception subsystem data: Perception subsystem data, as presented herein, corresponds with sensor data of perception sensors. Perception sensors in autonomous vehicles collect data used for detecting, identifying, classifying, and tracking objects in the surrounding environment of the autonomous vehicle. Examples of perception sensors include cameras, stereo camera, Light Detection and Ranging (LiDAR) sensor, Radio Detection and Ranging (RADAR) sensor, ultrasonic sensors, and inertial measurement unit (IMU) sensors.

A polyhedron: A polyhedron is a three-dimensional object having faces, edges, and vertices. Faces are flat sides of a polyhedron, and therefore are two-dimensional polygons. Edges are line segments where two faces meet, and vertices are points where two or more edges meet. Vertices are also referenced herein as corners. An example of a polyhedron is a cuboid.

A cuboid: A cuboid (box) in a three-dimensional (3D) space has eight vertices, which can be defined using the minimum and maximum points of a bounding box. The eight vertices are calculated by combining the x, y, and z coordinates of the edge points in all possible combinations.

Z-buffer: Z-buffer, also known and referenced herein as a depth buffer, is a type of data buffer that is used for representing depth information of objects in a three-dimensional (3D) space from a particular perspective such as, an ego vehicle's perspective. The depth is stored as a height map of the scene surrounding the ego vehicle such that the value of 0 represents the closest distance from a sensor (such as a camera sensor) and a larger value represents the farthest distance from the sensor. Depth buffers aid in rendering a scene to ensure that the correct polygons properly occlude other polygons. While a Z-buffer is used in the systems and methods described herein to determining overlapping polygons, another algorithm such as the painter's algorithm may also be used. However, the painter's algorithm is capable of handling non-opaque scene elements at the cost of efficiency.

As described herein, one of many challenges for the ADAS stack is to have a dataset that includes many different types of driving scenarios or conditions including occluded objects. Generally, the ADAS stack is developed and tested using database including simulation data. Accordingly, it is important that the simulation data cover a realistic occlusion modeling in policy simulation. Currently, occlusion is computed via polyhedron vertices using a geometrical approach in which, e.g., the vertices of a bounding box are calculated based upon the minimum and maximum values of the x, y, and z coordinates of all points within the object to be bound, and then combining those values to create the eight corner points of the bounding box. Accordingly, a polyhedron is formed that fully encloses the object. However, occlusion computing using polyhedron vertices approach requires extensive computing power.

Various embodiments as described herein, for occlusion computation improves computing power requirements using a computationally efficient approach that is not based on vertices of polyhedrons. The computationally efficient approach, which is based on a 3D rendering engine using a Z-buffer, increases fidelity of the inputs to the policy simulations, which can be used for autonomous vehicles virtual validation.

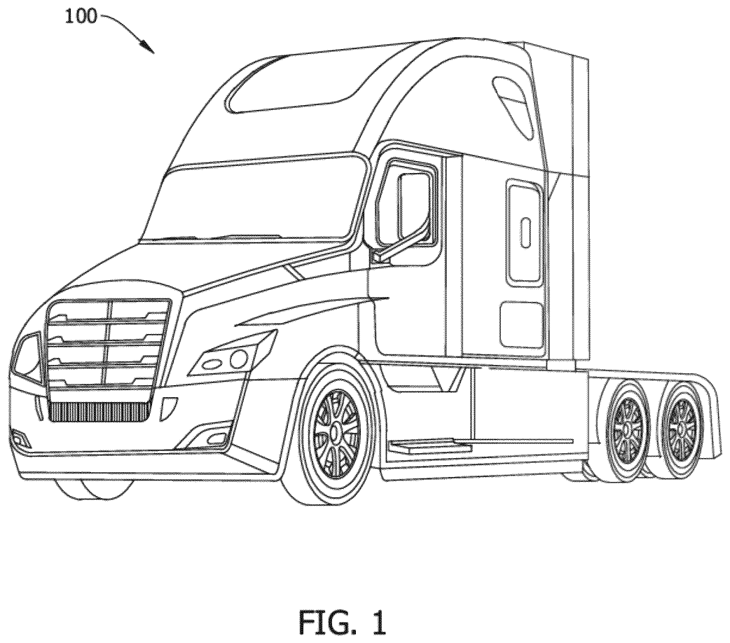

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

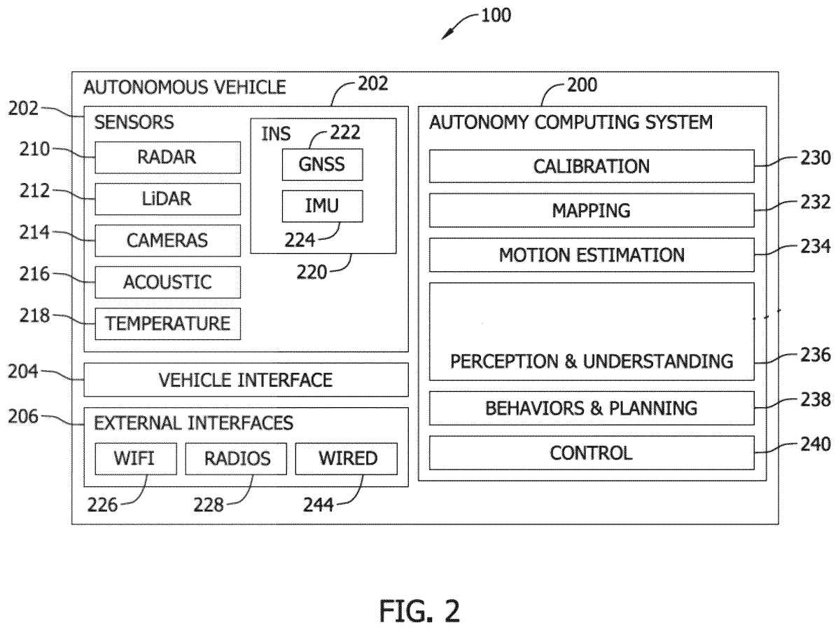

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.). By way of an example, the radios 228 may also include radios or other communication devices for V2X communication.

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

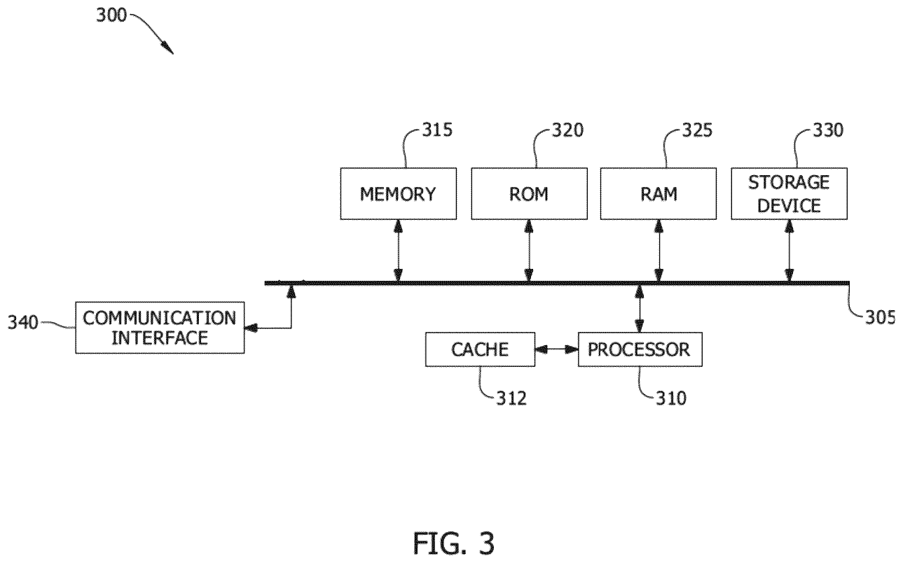

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, one or more other vehicles using V2V communication, or with one or more vehicles, pedestrians, or infrastructure using V2X communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; (iv) communication protocol according to 3GPP standard; and (v) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

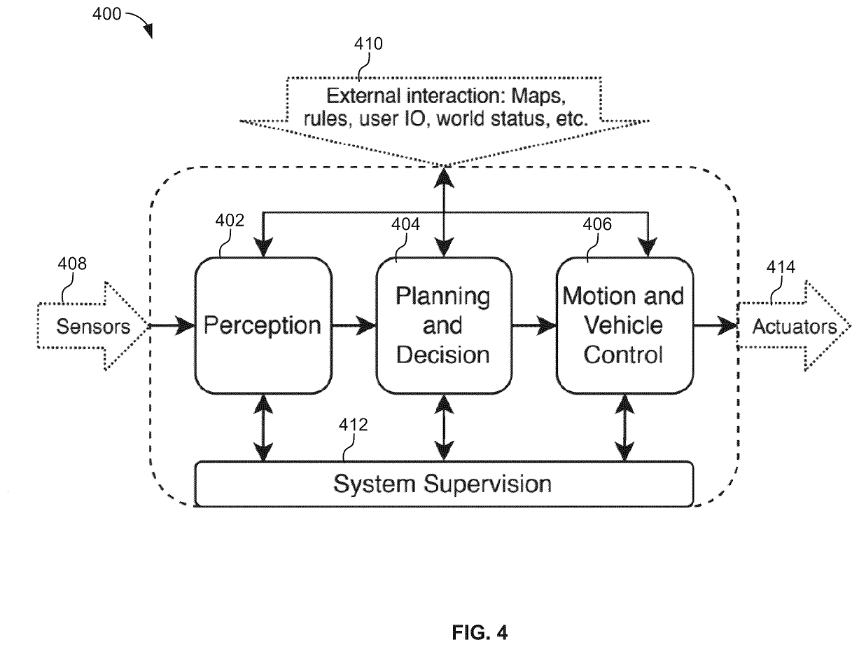

FIG. 4 is an example software stack architecture 400 of an autonomous vehicle including high level subsystems such as a perception subsystem 402 (or perception and understanding module 236 shown in FIG. 2), a planning and decision policy subsystem 404 (or behaviors and planning module 238 shown in FIG. 2), and a motion control (or a vehicle control) subsystem 406 (or control module 240 shown in FIG. 2). The perception subsystem 402 enable an autonomous vehicle to sense and process its environment. The environment is sensed using sensor data 408 and external interaction data 410. As shown in FIG. 4, the sensor data 408 may include sensor data of one or more camera sensors (e.g., camera sensors 214 shown in FIG. 2), one or more LiDARs (e.g., LiDAR sensors 212 shown in FIG. 2), or one or more RADARs (e.g., RADAR sensors 210 shown in FIG. 2). External interaction data 410 may include data associated with maps, user inputs, one or more rules, etc. The sensor data 408, and the external interaction data 410 are processed by the perception subsystem 402 based upon instructions or commands received from a system supervision subsystem 412.

The perception subsystem 402 identifies and classifies objects, or groups of objects, in the environment, for example, pedestrians, vehicles, or debris. Additionally, the perception subsystem 402 determines, based on the sensed environment, for example, where in the world, or on a map, the autonomous vehicle is. Additionally, the perception subsystem 402 processes features in the sensed environment to correlate, or register, those features to known features on a map provided in the external interaction data 410.

Planning and decision policy subsystem 404 determines how to move the autonomous vehicle through the sensed environment by the perception system 402 and based upon the external interaction data 410 and instructions or commands received from the system supervision subsystem 412 to generate an output. Output of the planning and decision policy subsystem 404 is fed as input to the motion control (the vehicle control) subsystem 406. The motion control (or the vehicle control) subsystem 406, further based upon the external interaction data 410 and instructions or commands received from the system supervision subsystem 412, generates an output in accordance with planned maneuvers and routes to reach the planned destination for execution to operate actuators. The generated output 412 uses control theory to determine how to translate desired behaviors and trajectories into actions undertaken by the autonomous vehicle through its dynamic mechanical components including, but not limited to, steering, braking and acceleration.

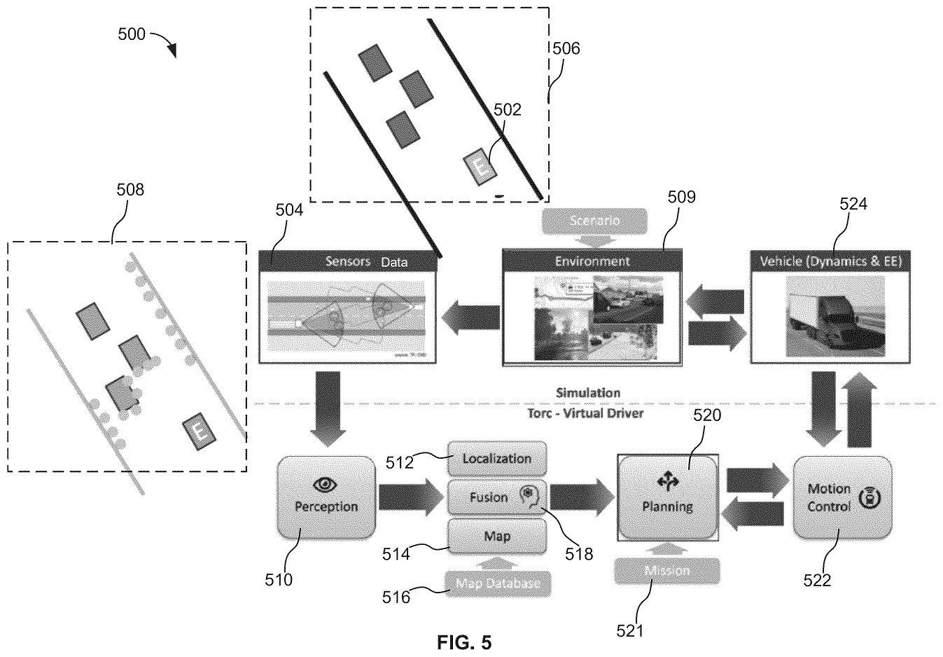

FIG. 5 is an illustration of a closed loop simulation 500 using the autonomy computing system 200 shown in FIG. 2. As shown in FIG. 5, sensors positioned at an autonomous vehicle (or an ego vehicle) 502 may generate sensor data 504 corresponding to a scene 506. The scene 506 perceived using sensors, for example, LiDAR sensors, may be shown as a scene 508 for an environment 509. The sensor data 504 is processed by a perception subsystem 510 (shown in FIG. 4 as perception subsystem 402), as described herein, to generate localization data 512. The localization data 512 and map data 514 from a map database 516 are fused 518 to generate an output that is provided to a planning and decision policy subsystem 520 (shown in FIG. 4 as planning and decision policy subsystem 404) as an input.

The planning and decision policy subsystem 520 determines how to move the autonomous vehicle through the sensed environment 509 based upon a planned trip for a particular destination or mission 521. The planning and decision policy subsystem 520 generates an output in accordance with planned maneuvers and routes to reach the planned destination for execution to perform motion control using a motion control subsystem 522. The motion control subsystem 522 (such as control module 240 shown in FIG. 2) controls dynamics and electrical engineering (EE) of the autonomous vehicle shown in FIG. 5 as 524. In the present disclosure, dynamics refers to the physical behavior and movement of the autonomous vehicle, including how it responds to steering inputs, acceleration, and road conditions, while “EE” encompasses the electronic systems that process sensor data, make control decisions, and ultimately drive the autonomous vehicle's dynamics to achieve autonomous navigation. It is to be noted here that various subsystems and their interactions, as shown in FIG. 5, form a closed loop simulation.

While the closed loop simulation, as shown in FIG. 5, executes all autonomous vehicle subsystems 510, 520, and 522, in a virtual testing, generation of synthetic data, such as the sensor data 504, is computationally expensive. In some examples, synthetic data generation requires more computational power than processing such sensor data in real time.

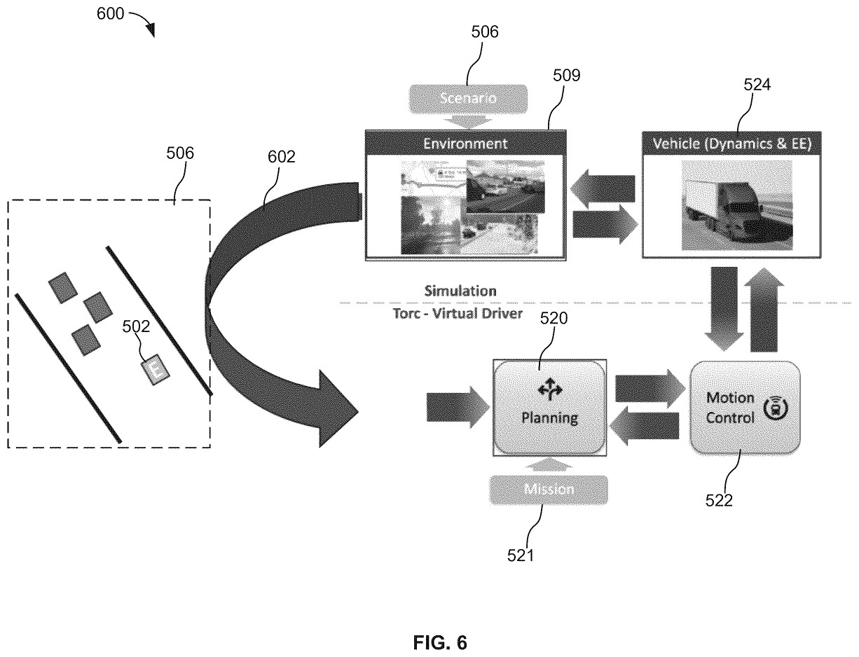

FIG. 6 is an example illustration 600 of an improved closed loop simulation which is not computationally expensive, and hence addresses drawbacks described herein with reference to FIG. 5. In particular, in the proposed closed loop simulation according to FIG. 6, an environment 509 is simulated and corresponding simulation data 602 is provided to a planning and decision policy subsystem 520 (shown in FIG. 4 as planning and decision policy subsystem 404) as an input. Accordingly, the autonomous vehicle subsystem 510 is eliminated from the closed loop simulation as shown in FIG. 6, and thereby improves computational efficiency at the expense of running the logic of the perception subsystem. The simulation data 602 represents perception data corresponding to various actors and environment that is passed to the planning and decision policy subsystem 520, as shown in FIG. 6.

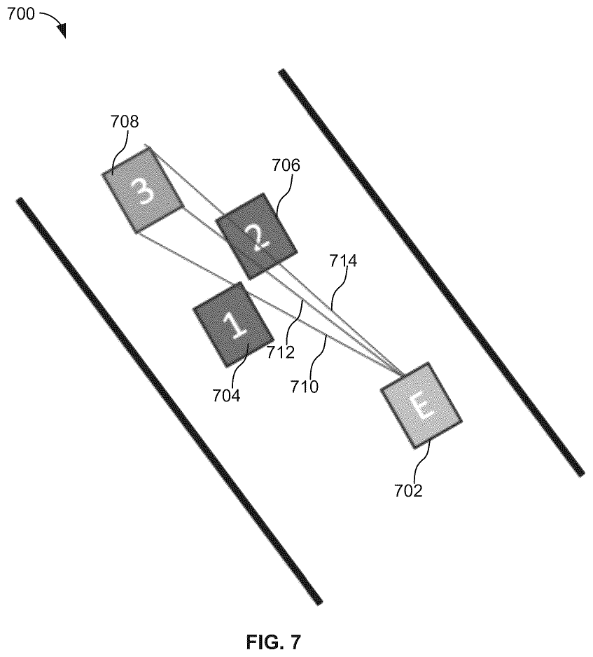

FIG. 7 is an example illustration 700 of policy simulation corresponding to an occlusion scenario of a plurality of different occlusion scenarios. An ego vehicle 702 and other actors 704, 706, and 708 may be situated as shown in FIG. 7. In the present case, an actor 708 may be occluded for the ego vehicle 702. An occlusion model may be generated for the given scenario shown in FIG. 7. In the occlusion model that is generated, any object that is occluded may not be passed to the planning and decision policy subsystem 520 shown in FIG. 6.

The planning and decision policy subsystem 520 determines how to move the autonomous vehicle through the sensed environment based upon a planned trip for a particular destination or mission 521. The planning and decision policy subsystem 520 generates an output in accordance with planned maneuvers and routes to reach the planned destination for execution to perform motion control using a motion control subsystem 522. The motion control subsystem 522 (shown in FIG. 4 as the motion control (or a vehicle control) subsystem 406) cause autonomous vehicle to operate as shown in FIG. 5 as 524. Whether a particular object is occluded from the ego vehicle 702's perspective, the occluded object and its corresponding simulation data are not processed through the motion control subsystem 522.

As described herein, whether an object is occluded or not is determined or computed geometrically, for example, using an occlusion model. The occlusion model is based on ray-tracing or checking visibility of edges or vertices of the object. In particular, the occlusion model is computed such that any object having visible surfaces is erroneously reported as occluded. Additional challenges may also include having an object with one or more corners and having visible surfaces as erroneously being reported as occluded. Currently known algorithms are based on, or optimized for, cuboids or simple vehicle shapes, which are computationally expensive, especially, in 3D high traffic density environment, due to the need to compare many polyhedrons to each other for determining whether a polyhedron is occluded by another polyhedron with respect to a direction of travel of the ego vehicle 702.

However, as shown in FIG. 7, lines 710, 712, and 714, may be used to identify an occluded object. In particular, lines 710, 712, and 714 may be used as a geometrical approach to check and identify an occlusion. If lines 710, 712, and 714 corresponding to the actor 708 intersect with other lines corresponding to another actor 704 or 706, the actor 708 is considered as an occluded object. In other words, occluded pixels relative to a total number of pixels for each object is determined, and based upon the occluded pixels, whether a particular object is occluded or not is determined.

If the particular object is determined to be occluded, then a percentage of occlusion is also determined. By way of an example, if no pixel of an object is visible, then the object is considered as 100% occluded. Similarly, if all pixels are visible, then the object is considered as 0% occluded.

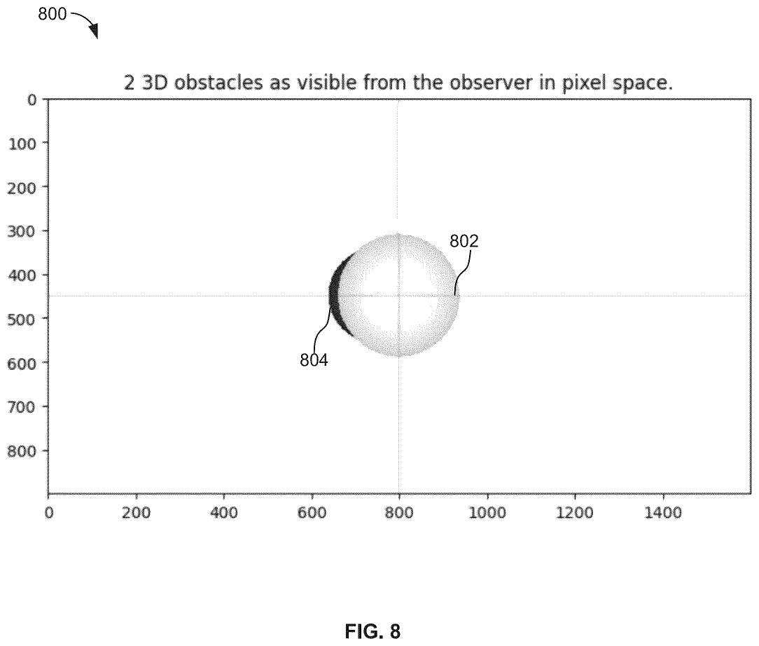

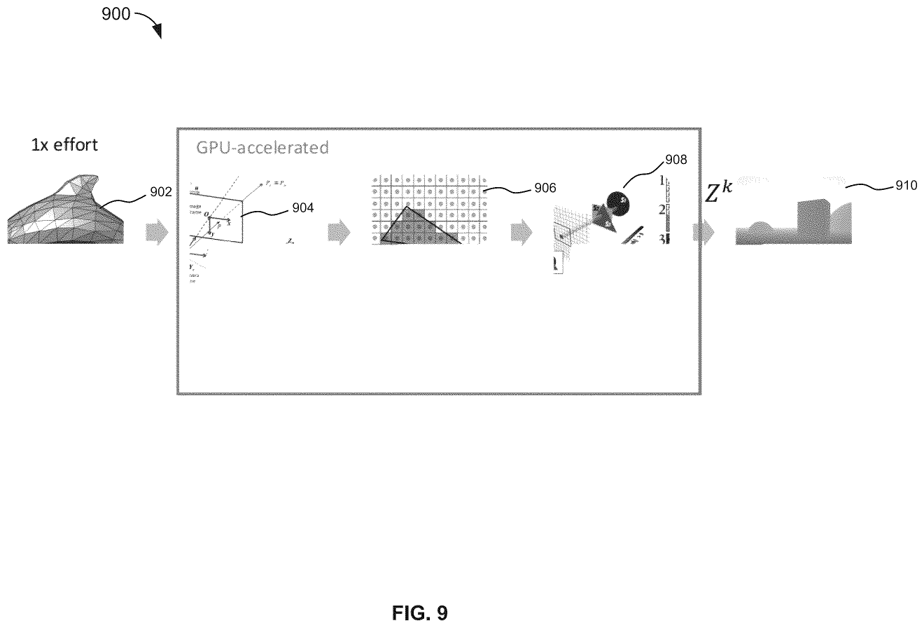

An example of object occlusion that is computed as described herein is shown in FIG. 8. As shown in a diagram 800, objects 802 and 804 are shown as visible from an observer (e.g., an ego vehicle) in pixel space. As shown in the diagram, the object 802 may be, for example, at 10 m distance away, and the object 804 may be, for example, at 13 m distance away. The object 804 is partly or mostly occluded by the object 802. In the example shown in FIG. 8, the object 804 is 91.2% occluded by the object 802, and the object 802 is 0% occluded. Object occlusion illustrated in FIG. 8 may be computed using an example implementation shown in FIG. 9.

FIG. 9 illustrates an example method 900 of computing object occlusion. As shown in FIG. 9, an object's surface 902 is represented as a plurality of faces. The plurality of faces may include, for example, triangles, quadrilaterals, hexagons, or simple convex polygons (n-gons). Assuming, for example, the plurality of faces includes triangles, each triangle may be formed of one or more predetermined edge sizes. For each triangle, its vertices are projected on a camera or pixel space 904. The Z-value (or depth) for each pixel from an ego vehicle's perspective is computed to generate rasterized triangles 906.

During generating the rasterized triangles 906, each primitive (or object, such as objects 802 and 804 shown in FIG. 8) in the ego vehicle's environment is converted to a two-dimensional bitmap. The two-dimensional bitmap is from the ego vehicle's perspective. Each bit (or a pixel) on the bitmap is characterized by its respective depth information. Thus, generating the rasterized triangles for a primitive consists of two parts. During the first part, various cells (or pixels) of an integer grid in pixel coordinates that are occupied by the projected faces of an object are determined, and during the second part, a depth value is determined and assigned to each cell (pixel). After generating the rasterized triangles 906, a depth or Z-value 908 for each pixel coordinate of the pixel is computed. Note that the Z-buffer matrix depicting the respective Z-value for each pixel of multiple pixels of a single primitive (or object) is initialized with the value “inf” (that is also referenced or known as an infinite value) and only the projected and rasterized parts of the object may differ from the initialized value “inf”. In the present disclosure, the “inf” value is a placeholder or an initial value, but other initialization values can also be used.

For example, for a visibility matrix V of a shape W×H, the visible object in the pixel coordinate (i,j) is

$${V}_{ij} = arg {min}_{k} {z}_{i j}^{k} ,$$

a Z-buffer for an object k is z^{k} (also the shape W×H) and an occlusion value for the object k is

$${o}^{κ} = 1 - \frac{sum ( V = k )}{sum ( {z}^{k} \neq inf )} .$$

The sum operation returns the number of Boolean true values of a matrix. The “argmin” operation is a sorting operation that sorts pixels based upon their distance (or depth) from the ego vehicle. Accordingly, the sorted pixels of the objects 910 identify a part of a particular object as either occluded part or not occluded part. Further, if the particular object is occluded, how much of the object is occluded is determined as described herein using FIG. 8.

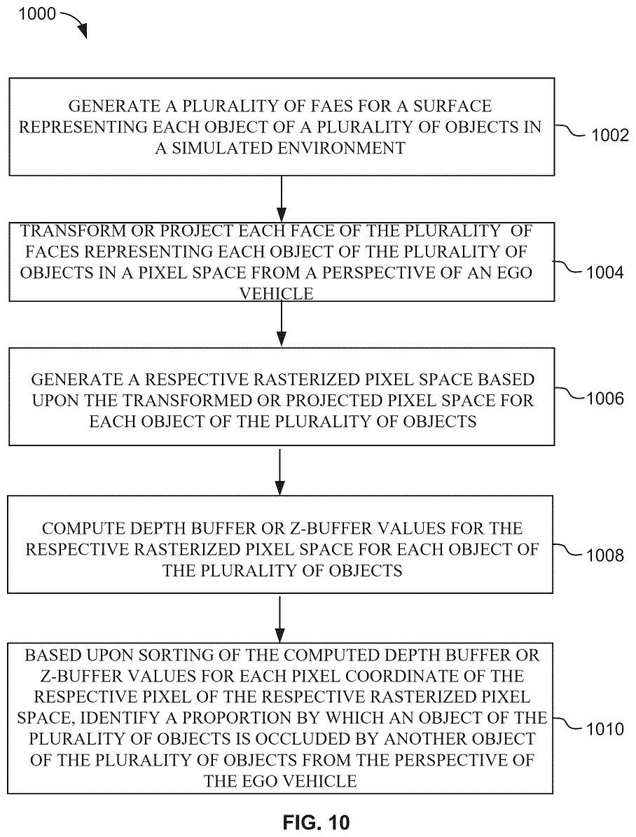

FIG. 10 is an example flow-chart 1000 of method operations of object occlusion computation. The method may be performed at an application server using a simulated database. The method operations include generating 1002 a plurality of faces for a surface representing each object of a plurality of objects in a simulated environment. The plurality of faces (e.g., triangles) for the surface representing each object of a plurality of objects in the simulated environment includes a plurality of faces (e.g., triangles) associated with one or more corner portions of each object of the plurality of objects in the simulated environment.

The method operations include transforming 1004 or projecting 1004 each face (e.g., a triangle) of the plurality of faces representing each object of the plurality of objects in a pixel space (e.g., a camera frame) from a perspective of an ego vehicle. The method operations include generating 1006 a respective rasterized pixel space based upon the transformed or projected pixel space for each object of the plurality of objects.

The method operations include computing 1008 depth buffer or Z-buffer values for the respective rasterized pixel space for each object of the plurality of objects. The method operations include identifying 1010 a proportion by which an object of the plurality of objects is occluded by another object of the plurality of objects from the perspective of the ego vehicle. The proportion by which the object of the plurality of objects is occluded by the other object of the plurality of objects is identified based upon sorting of the computed depth buffer or Z-buffer values for each pixel coordinate of the respective pixel of the respective rasterized pixel space.

Further, the proportion by which the object of the plurality of objects is occluded by the other object of the plurality of objects is determined or identified by computing a portion of the rasterized camera frame or the rasterized pixel space of the object that is also occupied by the rasterized camera frame or the rasterized pixel space of the other object. Additionally, when the depth buffer or Z-buffer value of the other object is closer to the ego vehicle in comparison with the depth buffer or Z-buffer value of the object, the other object occludes the object having a larger or greater value of the depth buffer or Z-buffer.

Additionally, or alternatively, from the perception subsystem data for the simulated environment from the perspective of an ego vehicle, perception subsystem data associated with the object that is completely or partly occluded (depending on a threshold) by one or more other objects of the plurality of objects may be removed to generate the revised perception subsystem data. The revised perception subsystem data is provided as an input to a planning and decision policy subsystem of an autonomous vehicle software stack architecture.

An example technical effect of the methods, systems, and apparatus described herein includes at least computationally efficient approach for occlusion computation. The computationally efficient approach, which is based on a 3D rendering engine using a Z-buffer, increases fidelity of the inputs to the policy simulations, which can be used for autonomous vehicles virtual validation.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system comprising:
at least one memory configured to store machine executable instructions; and
at least one processor coupled to the at least one memory and configured to execute the machine executable instructions to:
generate a plurality of faces for a surface representing each object of a plurality of objects in a simulated environment;
transform or project each face of the plurality of faces representing each object of the plurality of objects in a pixel space from a perspective of an ego vehicle;
generate a respective rasterized pixel space based upon the transformed or projected pixel space for each object of the plurality of objects;
compute depth buffer or Z-buffer values for the respective rasterized pixel space for each object of the plurality of objects; and
based upon sorting of the computed depth buffer or Z-buffer values for each pixel coordinate of the respective pixel of the respective rasterized pixel space, identify a proportion by which an object of the plurality of objects is occluded by another object of the plurality of objects from the perspective of the ego vehicle.

2. The system of claim 1, wherein to identify the proportion by which the object is occluded by the other object, the at least one processor is further configured to execute the machine executable instructions to compute a portion of the rasterized camera frame or the rasterized pixel space of the object that is also occupied by the rasterized camera frame or the rasterized pixel space of the other object, wherein the depth buffer or Z-buffer value of the other object is closer to the ego vehicle in comparison with the depth buffer or Z-buffer value of the object.

3. The system of claim 1, wherein the plurality of faces for the surface representing each object of a plurality of objects in the simulated environment includes a plurality of faces associated with each object of the plurality of objects in the simulated environment.

4. The system of claim 1, wherein the at least one processor is further configured to execute the machine executable instructions to generate revised perception subsystem output data by removing perception subsystem data associated with the object occluded by one or more other objects of the plurality of objects from the perception subsystem data for the simulated environment from the perspective of an ego vehicle.

5. The system of claim 4, wherein the revised perception data is provided as an input to a planning and decision policy subsystem of an autonomous vehicle software stack architecture.

6. The system of claim 4, wherein the object is completely or partly occluded by one or more other objects of the plurality of objects.

7. The system of claim 4, wherein the sensor data includes sensor data collected by one or more camera sensors.

8. A computer-implemented method comprising:
generating a plurality of faces for a surface representing each object of a plurality of objects in a simulated environment;
transforming or projecting each face of the plurality of faces representing each object of the plurality of objects in a pixel space from a perspective of an ego vehicle;
generating a respective rasterized pixel space based upon the transformed or projected pixel space for each object of the plurality of objects;
computing depth buffer or Z-buffer values for the respective rasterized pixel space for each object of the plurality of objects; and
based upon sorting of the computed depth buffer or Z-buffer values for each pixel coordinate of the respective pixel of the respective rasterized pixel space, identifying a proportion by which an object of the plurality of objects is occluded by another object of the plurality of objects from the perspective of the ego vehicle.

9. The computer-implemented method of claim 8, wherein identifying the proportion by which the object is occluded by the other object comprises computing a portion of the rasterized camera frame or the rasterized pixel space of the object that is also occupied by the rasterized camera frame or the rasterized pixel space of the other object, wherein the depth buffer or Z-buffer value of the other object is closer to the ego vehicle in comparison with the depth buffer or Z-buffer value of the object.

10. The computer-implemented method of claim 8, wherein the plurality of faces for the surface representing each object of a plurality of objects in the simulated environment includes a plurality of faces associated with each object of the plurality of objects in the simulated environment.

11. The computer-implemented method of claim 8, further comprising generating revised perception subsystem output data by removing perception subsystem data associated with the object that is occluded by one or more other objects of the plurality of objects from the perception subsystem data for the simulated environment from the perspective of an ego vehicle.

12. The computer-implemented method of claim 11, wherein the revised perception subsystem output data is provided as an input to a planning and decision policy subsystem of an autonomous vehicle software stack architecture.

13. The computer-implemented method of claim 11, wherein the object is completely or partly occluded by one or more other objects of the plurality of objects.

14. The computer-implemented method of claim 11, wherein the sensor data includes sensor data collected by one or more camera sensors.

15. An application server comprising:
at least one memory configured to store machine executable instructions; and
at least one processor coupled to the at least one memory and configured to execute the machine executable instructions to:
generate a plurality of faces for a surface representing each object of a plurality of objects in a simulated environment;
transform or project each face of the plurality of triangles representing each object of the plurality of objects in a pixel space from a perspective of an ego vehicle;
generate a respective rasterized pixel space based upon the transformed or projected pixel space for each object of the plurality of objects;
compute depth buffer or Z-buffer values for each pixel of the respective rasterized pixel space for each object of the plurality of objects; and
based upon sorting of the computed depth buffer or Z-buffer values for each pixel coordinate of the respective pixel of the respective rasterized pixel space, identify a proportion by which an object of the plurality of objects is occluded by another object of the plurality of objects from the perspective of the ego vehicle.

16. The application server of claim 15, wherein to identify the proportion by which the object is occluded by the other object, the at least one processor is further configured to execute the machine executable instructions to compute a portion of the rasterized camera frame or the rasterized pixel space of the object that is also occupied by the rasterized camera frame or the rasterized pixel space of the other object, wherein the depth buffer or Z-buffer value of the other object is closer to the ego vehicle in comparison with the depth buffer or Z-buffer value of the object.

17. The application server of claim 15, wherein the plurality of faces for the surface representing each object of a plurality of objects in the simulated environment includes a plurality of faces associated with each object of the plurality of objects in the simulated environment.

18. The application server of claim 15, wherein the at least one processor is further configured to execute the machine executable instructions to generate revised perception subsystem output data by removing perception subsystem data associated with the object occluded by one or more other objects of the plurality of objects from the perception subsystem data for the simulated environment from the perspective of an ego vehicle.

19. The application server of claim 18, wherein the revised perception subsystem data is provided as an input to a planning and decision policy subsystem of an autonomous vehicle software stack architecture.

20. The application server of claim 18, wherein the sensor data includes sensor data collected by one or more camera sensors, and the object is completely or partly occluded by one or more other objects of the plurality of objects.
